(19) United States
(12) Patent Application Publication
(10) Pub. No.: US 2007/0170141 A1
(43) Pub. Date: Jul. 26, 2007

(54) Cargo scanning device

(76) Inventor: Robert Newhouse, Florham Park, NJ (US)

Correspondence Address: HOFFMANN & BARON, LLP, 6900 JERICHO TURNPIKE, SYOSSET, NY, 11791, US

(21) Appl. No.: 11/657,867

(22) Filed: Jan. 25, 2007

Related U.S. Application Data
(60) Provisional application No. 60/762,024, filed on Jan. 25, 2006.

(51) Int. Cl. B66C 17/00

(52) U.S. Cl. 212/312

(57) ABSTRACT

The present invention provides for a scanning device including a radiation scanning component for scanning the contents of cargo containers. The radiation scanning component is attached to a spreader bar of a crane system such that the container is surrounded on either side by the radiation scanning device upon securement of the container to the spreader bar. The scanning and unloading/loading of cargo are a simultaneous operation providing for time and cost efficiency. The present invention further provides for a method of scanning a container using the scanning device of the present invention.

### CROSS-REFERENCE TO RELATED APPLICATIONS

The present application claims priority to Provisional Application No. 60/762,024, filed Jan. 25, 2006, and entitled, “CARGO SCANNING DEVICE”, herein incorporated by reference.

### FIELD OF THE INVENTION

The present invention relates to a cargo scanning device. Specifically, the present invention is related to a radiation cargo scanning device for containers used in the shipping industry.

### BACKGROUND OF THE INVENTION

Radiation is commonly used in the non-invasive inspection of objects such as luggage, bags, briefcases, and the like to identify hidden contraband and smuggled goods. Contraband includes guns, knives, explosive devices, as well as illegal drugs, for example. Smuggled goods may be identified by comparing the detected contents of objects with a manifest listing of the contents of the objects. As criminals and terrorists have become more creative in the way they conceal contraband, the need for more effective non-invasive inspection techniques has grown. While the smuggling of contraband onto planes in carry-on bags and in luggage has been a well-known, on-going concern, a less publicized but also serious threat is the smuggling of contraband by boat in large cargo containers.

One common inspection system is a line scanner, where an object to be inspected is passed between a stationary source of radiation, such as X-ray radiation, and a stationary detector. Fixed inspection systems have been proposed for inspecting large containers. A conveyor or truck moves the package or container horizontally between the X-ray source supported on a floor and a detector array.

Some mobile scanning x-ray systems include a frame system which is set-up on the docks. The cargo from the ship is removed by crane and placed on a truck. The truck then passes through the x-ray tunnel-like system and the cargo is scanned accordingly. Such systems tend to be expensive, heavy, complex and difficult to transport and set up. Inspection may be slow. Some systems require several days to assemble and disassemble. Other systems are so long and/or heavy, that they require a special road permit to be driven on highways.

As a result of the time consuming examination process less than three percent of cargo containers arriving in the U.S. are inspected. If more cargo was inspected then it would cause a drastic slow down in day to day port operations. A slow down on a port would exponentially increase the cost of imported and exported goods and ultimately affect the consumer and economy. A more time efficient and cost efficient improved radiation inspection systems for shipping cargo containers is needed to national security purposes as well as providing adequate required inspection.

None of the prior scanning devices satisfactorily provided the efficiency of inspection of cargo that is desired. It is therefore desirable to provide such a device that will allow cargo to be easily and efficiently be inspected. In addition, the device must provide the necessary level of inspection and reliability required to secure port. Further, a low cost and efficient device is desired.

### SUMMARY OF THE INVENTION

These and other features of the present invention are evident from the drawings along with the detailed description of preferred embodiments. The present invention provides for a scanning device including a radiation scanning component for scanning the contents of cargo containers. The radiation scanning component is attached to a spreader bar of a crane system such that the container is surrounded on either side by the radiation scanning device upon securement of the container to the spreader bar.

The present invention further provides for a scanning device for shipping cargo. The scanning device includes a mobility system and a radiation system. The scanning device is attached to a spreader bar of a crane system. The mobility system includes at least one geared track and gear wheel and the geared track extends the length of a shipping container. The gear wheel is engageable with said geared track to cooperatively move the gear wheel there along. The radiation system is attached to the gear wheel. The radiation system includes a radiation emitting source and a radiation receiving source. The radiation system may include a scanning arm and a backstop. The scanning arm is attached to the gear wheel. The scanning arm has a radiation source to emit radiation and the backstop is attached to the scanning arm for receiving or deflecting radiation there from. The container is located between the scanning arm and the backstop.

The present invention further provides for a method of scanning a cargo container including attaching a scanning device to a crane system; securing a container to the crane system for unloading/loading the container; moving the scanning device along the container to emit radiation there along; and detecting radiation interacting with the container.

The scanning device of the present invention allows for scanning of any number of cargo containers entering and leaving a port during normal loading/unloading operation procedures without delaying the regular operation of the port. The scanning device may detect discrepancies with the listed cargo on the shipping manifest and detect nuclear or other hazardous material.

### BRIEF DESCRIPTION OF DRAWINGS

FIG. 1 is a schematic representation of a scanner device of the present invention supported by a crane.

FIG. 2 is a side view of the scanner device of the present invention.

FIG. 3 is a top view of the scanner device of the present invention.

### DETAILED DESCRIPTION

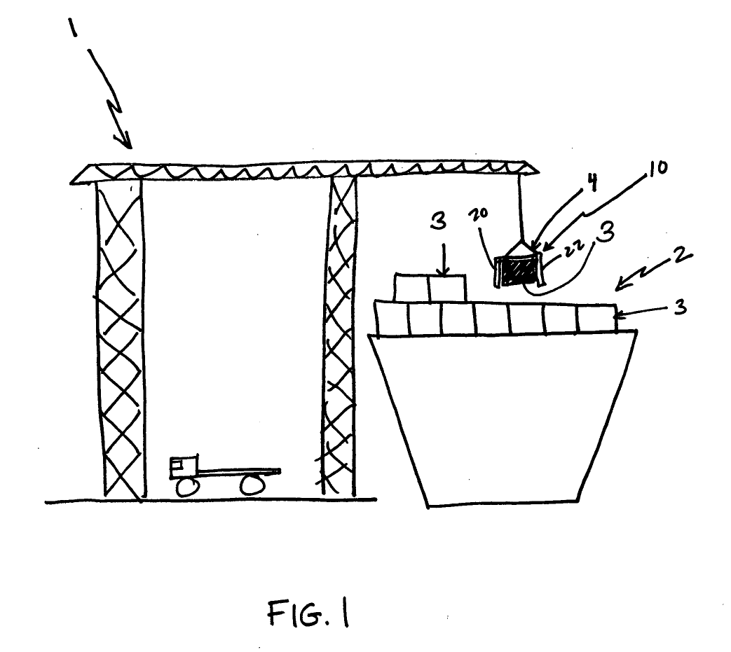

Referring in more detail to the drawings, as shown in FIGS. 1-3, a preferred embodiment of the present invention is described. Generally, the scanner device 10 attaches to a standard crane system 1 for unloading and loading cargo 2, such as containers 3 and pallets from a ship at a seaport. The crane is designated to lift cargo from one location to another location. The scanner device 10 of the present invention is attached to the crane in such a way as to not interfere with the function of the crane. The scanner device 10 inspects the cargo during normal crane operation to provide for uninterrupted loading and unloading of cargo, a time efficient scanning system.

FIG. 1 shows the crane system 1 including opposing vertical structures which support a boom arm. A conveying system is supported by the boom arm. The conveying system includes a carriage or spreader bar 4 which is suspended from a chain or metal rope. The chain is driven around pulleys by a motor to lift and lower the spreader bar 4. The spreader bar 4 is used to secure the cargo 2 to the crane system 1. The spreader bar 4 lifts the cargo off of the ship vertically and moves the container 3 horizontally along the boom arm toward the seaport. The container 3 is then lowered vertically onto a truck, seaport dock or railcar. The spreader bar 4 releases the container 3 and returns to the ship to secure another piece of cargo to remove from the ship. The process is reversed to load cargo from the dock, trucks or railcars onto a ship.

The scanner device 10 of the present invention is attached to the spreader bar 4. During the transportation of the cargo by the spreader bar 4, the scanner device 10 inspects the contents of the cargo. This provides for uninterrupted loading/unloading of the cargo and scanning of the cargo simultaneously.

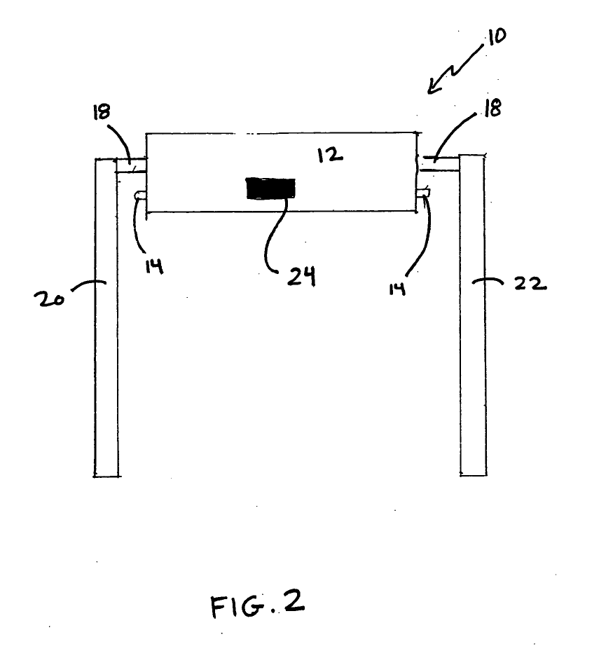

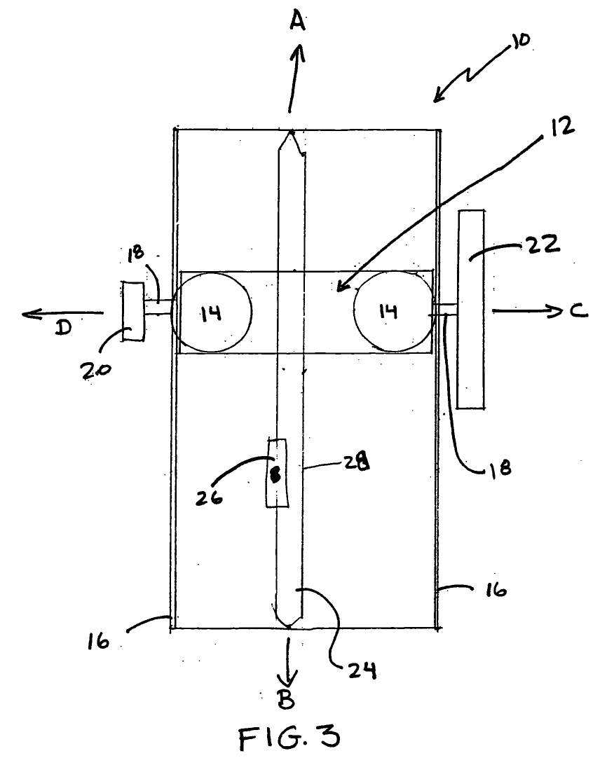

FIGS. 2 and 3 show the scanner device 10 includes a main body 12 which contains geared system. The geared system includes a gear wheel 14 which runs along a geared track. The gear wheel 14 engages with the geared track 16 to provide for movement of the scanner along the length of the cargo contained in the direction of vector A and vector B. On either side of the main body 12 is a hydraulic piston 18 connected thereto. The hydraulic piston 18 is used to move a scanning arm 20 and/or an x-ray back stop 22 toward or away from the main body 12 in the direction of vector C or vector D. The scanning arm 20 is located on one side of the main body 10 and the x-ray back stop 22 is located on the other side of the main body 10. The scanning arm 20 is a scanning wand which contains a scanning eye to x-ray the container located between the scanning arm 20 and x-ray back stop 22. The x-ray back stop 22 provides a surface for the scanner to reflect and/or receive the x-rays as well as prevent x-rays from traveling beyond the back stop 22. Further included in the scanner device 10 is a counterweight system 24. The counterweight system 24 includes a counterweight 26 and a counterweight arm 28. The counterweight 26 travels along the arm 28 to counterbalance the main body 12 of the scanner device 10 as it moves along the geared track 16.

Generally, during transit of a container 3 on the gantry crane 1, the scanner device 10 will make one pass over the container 3. The scanner device 10 will be incorporated into the spreader bar 4 as the container 3 is moved. The scanner device 10 will quickly scan and the image will be sent to a special network. The network could have the shippers' information on the cargo appear on the screen next to the digital scan images to provide a side by side comparison which a trained operator could determine to be consistent or inconsistent. An inconsistent comparison would flag the container to be brought to the customs inspection area.

In operation, the spreader bar 4 secures the cargo 2 between the scanning arm 20 and the backstop 22. The scanning arm 20 emits radiation beams onto the container 3 and the backstop detects radiation transmitted through the container 3. The main body 12 of the scanning device 10 moves along the gear track 16 to scan the entire container 3 during standard loading/unloading procedures by the crane.

The radiation beam is a horizontally diverging beam. The radiation beam may be a fan beam having only one dimensional direction or a cone beam having two dimensional directed beams, i.e., horizontal and vertical. The cone beam may vary in dimension, for example, having an outer edge cross-section of a square, rectangle, circular, or other geometric shape.

The radiation source of the scanner arm 20 may be x-ray radiation, i.e. Bremsstrahlung radiation; a linear accelerator, i.e. Linatron®; electrostatic accelerators, microtrons and betatrons; and x-ray tubes may be used.

The backstop 22 is used to detect the beam emitted from the scanner arm 20. The backstop 22 may be a one dimensional detector array comprising modules of detection elements as known in the art. The elements may include a radiation sensitive detector, a photosensitive detector or other surveillance and scanning detectors as known in the art.

The backstop 22 is electronically coupled to or wirelessly conjoined to a processor, i.e. computer. The processor reconstructs the data output by the backstop 22 into images which can be displayed on a monitor, data output or other source of useable real-time output for an operator to verify the contents within the cargo container. The data may be further used to compare the manifest documents identifying the contents of that container, or loading slips either electronically or manually for verification of cargo.

The scanner device 10 may further include a shielding portion to capture scattered radiation. For example, a lead curtain may be incorporated with the backstop 22 to prevent scattered radiation and protect workers during the scanning process.

The scanning device 10 may further provide for the scanning arm 20 and back stop 22 to be lowered into position during use, i.e. either side of the container 3, and moved out of the way during nonuse of the scanning device 10. Moving the scanning arm 20 and back stop 22 provides for clearance below the spreader bar 4 during nonuse and protects the arm 20 and back stop 22 from damage. For example, the scanning arm 20 and backstop 22 may be rotated about the piston 18 to align with the main body 10 during nonuse. Another alternative is the scanning arm 20 and back stop 22 may be vertically raised above the main body 10 and the lower portion of the spreader bar 10 to provide clearance below the spreader bar 10.

The scanning device 10 of the present invention is designed to examine cargo as fast as they can be moved by the crane system 1. The scanning process is performed once the cargo is lifted and clears the ship and before it is placed on the truck of loading dock. The radiation activity of the present invention is a safer operation then those known in the art because the scanning is being performed during the loading/unloading instead of on the dock or ship exposing workers to radiation.

The present invention provides for a more efficient use of a scanning device at a seaport. The unloading/loading of cargo onto a ship and the scanning of that cargo becomes a one step process. Further, the scanning device 10 is easily attached to and supported by the crane system to allow for easy attachment and removal of the scanning device. Furthermore, dock space is maximized by having this scanning system off the dock as well as the crane.

The scanning device 10 describes a radiation scanner that provides images of the interior of various containers. However, the present invention includes various scanning devices used for identification and inspection of cargo including but not limited to detecting of radiation, detecting biochemical contamination, detecting chemical hazards, detecting nuclear emissions, detecting nuclear material, detecting x-ray, gamma ray and/or neutron emissions, detecting specific vapor or gas emissions produced, and the like. The scanning device may include a combination of various inspection devices. All the various types of scanning devices are attached to the spreader bar as above-described to provide the benefits discussed including time savings, reliability and user friendly way of scanning while limiting exposure to workers of various hazards and without limiting dock space.

Having described the preferred embodiments herein, it should now be appreciated that variations may be made thereto without departing from the contemplated scope of the invention. Accordingly, the preferred embodiments described herein are deemed illustrative rather than limiting, the true scope of the invention being set forth in the claims appended hereto.

What is claimed is:

1. A scanning device comprising:
a radiation scanning component for scanning the contents of cargo containers, said radiation scanning component is attached to a spreader bar of a crane system such that said container is surrounded on either side by said radiation scanning device upon securement of said container to said spreader bar.

2. A scanning device for shipping cargo, comprising:
a scanning device including a mobility system and a radiation system, said scanning device is attached to a spreader bar of a crane system;
said mobility system including at least one geared track and gear wheel, said geared track extends the length of a shipping container, said gear wheel is engageable with said geared track to cooperatively move said gear wheel therealong; and
said radiation system attached to said gear wheel, said radiation system comprises a scanning arm and a backstop, said scanning arm is attached to said gear wheel, said scanning arm having a radiation source to emit radiation, said backstop attached to said scanning arm for receiving or deflecting radiation there from, said container is between said scanning arm and said backstop.

3. A method of scanning a cargo container comprising:
attaching a scanning device to a crane system;
securing a container to said crane system for unloading/loading said container;
moving said scanning device along said container to emit radiation there along; and
detecting radiation interacting with the container.
